(19) United States
(12) Patent Application Publication
(10) Pub. No.: US 2025/0148052 A1
(43) Pub. Date: May 8, 2025

(54) SYSTEMS AND METHODS FOR AUTOMATED ALERT CLASSIFICATION AND TRIAGE

(71) Applicant: SecureWorks Corp., Atlanta, GA (US)

(72) Inventors: Curtis Yasm, Signal Mountain, TN (US); Melissa Turcotte, Santa Fe, NM (US); Mark Mojkowski, Raynham, MA (US); Smita Borkar Neelarambam, Ashburn, VA (US); Serge-Olivier Paquette, Montreal (CA); Jason Plata, Miami, FL (US)

(21) Appl. No.: 18/929,810

(22) Filed: Oct. 29, 2024

Related U.S. Application Data
(60) Provisional application No. 63/596,051, filed on Nov. 3, 2023.

(51) Int. Cl. G06F 18/2415; G06N 20/00

(52) U.S. Cl. CPC G06F 18/2415; G06F 21/554

(57) ABSTRACT

Systems and methods are provided for automatically classifying and triaging alerts. A probabilistic classification machine learning model is trained using historical alerts and the actions taken for each of the historical alerts. When a new alert is received, it is categorized. A feature vector is created using information associated with the alert and count information associated with other recently received alerts that have the same category or at least one common entity with the alert. Count information for attributes and combinations of attributes for recently received alerts is maintained in a time series database. The machine learning model is applied to the feature vector to determine a suggested action. Once an analyst action is taken with respect to the alert, the count information in the time series database is updated.

### CROSS REFERENCE TO RELATED APPLICATION

This application claims priority to U.S. Provisional Application No. 63/596,051, filed Nov. 3, 2023, entitled “SYSTEMS AND METHODS FOR AUTOMATED ALERT CLASSIFICATION AND TRIAGE”, the disclosure which are hereby incorporated by reference in its entirety.

### TECHNICAL FIELD

The present disclosure relates to a system for processing alerts associated with potential cybersecurity attacks and triaging the alerts prior to providing them to a security analyst. The present disclosure relates in particular to identifying similar alerts and using machine learning techniques to assess the likelihood of an action being taken for an alert that considers both long term and short term trends in actions taken for similar alerts.

### BACKGROUND

Cybersecurity systems oftentimes rely on alerts to notify security analysts of suspicious and potentially malicious activity, which the security analysts manually review to identify cybersecurity attacks and other security events. Alert fatigue is a common problem among security analysts, as security analysts are often inundated with alerts, many of which may be benign or not relevant. As the volume of alerts increases, it becomes increasingly difficult for analysts to identify the most severe and relevant threats quickly and accurately, leading to decreased efficiency and effectiveness, as well as delays in responding to the alerts. Thus, there exists a need for systems to process an alert before sending the alert to an analyst to allow security analysts to focus on the most severe and relevant threats. The processing may identify potential actions for the alert or automatically take action on the alert.

### SUMMARY

The present disclosure describes systems and methods for automatically classifying and triaging alerts to provide improved system security. A machine learning model is trained using historical alerts and the outcomes for each historical alert as determined by an analyst.

Once trained the model may be used to process new alerts. The system receives an alert, which may be a notification of suspicious or malicious activity and classifies, i.e., categorizes the alert. Once the alert is categorized, the system can use the category to identify counters from a time series database that have the same category or at least one entity in common with the alert. The time series database includes counters that count attributes and combinations of attributes for alerts associated with a set period of time, such as the preceding 24 hours, 7 days or 30 days. The system creates a feature vector for the alert. The feature vector includes static features and dynamic features. The static features may include or be based upon information from the alert. The dynamic features are derived using the counters in the time series database that have the same category or the same entity/entities as the current alert. The dynamic features may be specific to the tenant associated with the alert or they may be global, i.e., consider alerts from all tenants.

The system provides the feature vector to the machine learning model and the machine learning model generates a set of probabilities, each probability associated with an action that may be taken with respect to the alert. When a probability exceeds a probability threshold, the alert and the action associated with the probability are provided to a security analyst. After the analyst takes action on the alert, the system updates the counters in the time series database using information about the alert and the action taken by the analyst. In some implementations, if the probability exceeds a probability threshold, then the method automatically takes action.

The machine learning model may include one or more of the following model families: logistic regression, random forests, gradient boosting trees, neural network, or any model that allows for either binary or multi-class label classification with a continuous range. The model is trained using historical alerts. Historical alerts are alerts previously triaged by an analyst. They are stored with a label and may be used for training purposes. The system can provide suggested actions that are based on both historical outcomes and more recent trends to reduce the time required to handle an alert, increase the accuracy in identifying an action for an alert, and improve the security of the system.

### BRIEF DESCRIPTION OF THE FIGURES

FIG. 1 is a block diagram illustrating an example of an alert and triage system.

FIG. 2 is a block diagram illustrating an example of the training of a machine learning model with historical alert data and the subsequent use of the model.

FIG. 3 is a flowchart illustrating an exemplary method of processing an alert.

FIG. 4 is a diagram illustrating an exemplary method of training a model using historical alert data.

FIG. 5 is a diagram illustrating an exemplary method of applying a model to a new alert.

### DETAILED DESCRIPTION

Aspects of the present disclosure relate to a system configured to construct and use a machine learning model, such as a probabilistic classification machine learning model, for triaging alerts for security events such as cyberattacks using both recent and historical data of the actions taken by security analysts. Briefly described, the system receives an alert and categorizes the alert. The system identifies similar alerts that were previously handled by an analyst based on the categorization of the alert and the entity/entities associated with the alert. The system creates a feature vector for the alert based on information from the alert and information associated with the similar alerts and applies the probabilistic classification model to the feature vector. The output of the model is a probability associated with a potential action that may be taken with respect to the alert. When a probability exceeds a threshold, the system may forward the alert and the probability information to the analyst or in some instances may automatically take the action associated with the probability.

An alert is generated by a security tool using telemetry data and typically includes information about the detected activity, such as log events, attack techniques, and entity/entities associated with the activity. An alert may include textual information, such as a title or description of the alert. An alert may also include entity information that identifies a person, machine, program, or other digital object that operates within or interacts with a computing environment. The entity information may include a unique entity identifier and may identify an entity where an attack originated or an entity impacted by an attack. Exemplary entities include IP addresses and hostnames.

The alert classification and triage system automates the triage of alerts and helps prevent alert fatigue. The system learns from the decisions of security analysts by modeling security analyst actions. The system uses this model to predict an action for a new alert, and when the model shows high enough confidence in a predicted action, the system may execute the predicted action. The system may further rank alerts and suggest actions that other security analysts performed when receiving a similar or matching alert.

### Example Alert and Triage System

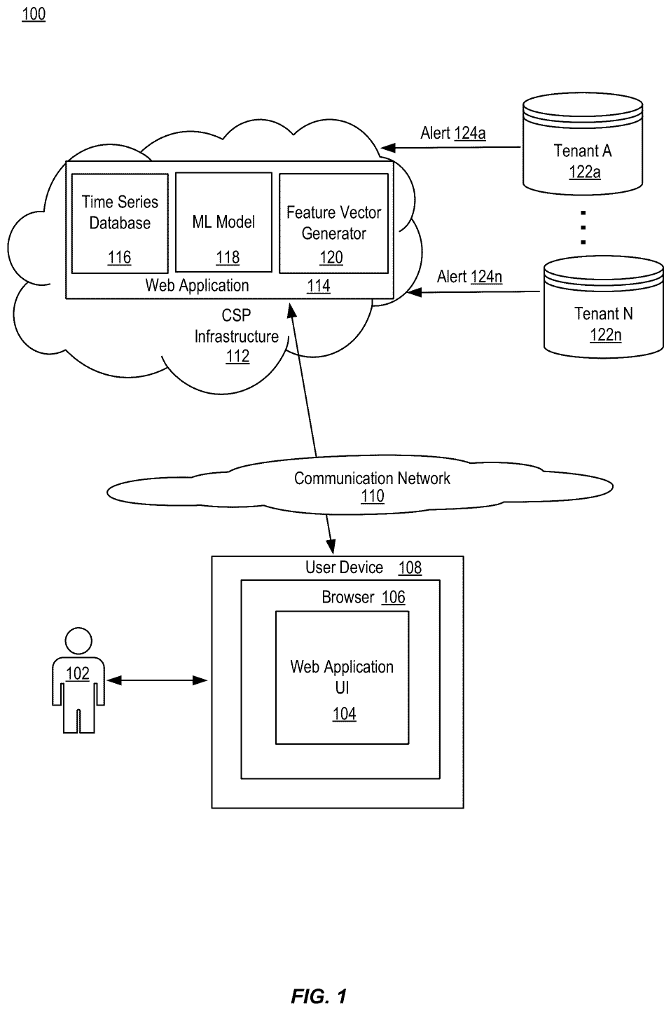

FIG. 1 illustrates an example alert and triage system 100. FIG. 1 depicts a security analyst 102 interacting with a web application user interface (UI) 104 through a browser 106 operated on a user device 108, such as a laptop, tablet, phone, or other computing device. The user device 108 communicates with web application 114 through a communication network 110, such as the internet. As shown in FIG. 1, web application 114 may be executed on cloud service provider (CSP) infrastructure 112. The cloud service provider infrastructure 112 may be comprised of various hardware and software components to facilitate the execution of web application 114, such as various servers, databases, communication devices, interfaces, and computing devices. In some alternative examples, instead of web application 114, an application is executed locally on the user device.

The web application 114 includes a time series database 116, a machine learning model 118, and a feature vector generator 120. Web application 114 receives alerts 124a and 124n from various sources, such as Tenant A 122a and Tenant N 122n. The alerts 124a, 124n are processed and a feature vector is generated for each alert. The machine learning model 118 is applied to each feature vector.

In some cases, the system may triage alerts arising from different tenants. Different tenants may rely on different rules or detection algorithms to generate alerts. The system has the flexibility to process alerts generated using different rules or detection algorithms and to learn from actions taken with respect to a specific tenant environment and actions taken across multiple tenants. This allows the system to consider how alerts have been handled at a particular tenant or across all tenants.

The machine learning model 118 generates a probability for potential actions that may be taken for the alert. Potential actions may include escalating an alert for further investigation, labeling an alert as malicious, or labeling an alert as not malicious. The alert, the potential actions, and optionally the probabilities for the potential actions may be provided to an analyst by displaying the information to the analyst, for example on the user device 108. The display of the information may include information for multiple alerts and each alert may be ranked or assigned a priority. The analyst may consider the rank/priority when selecting an alert for handling or the probability information when deciding on an action. Alternatively, when the probability exceeds a predetermined threshold, the system may automatically initiate the action associated with the probability. Once an analyst takes action on the alert, the alert and the associated action may be used to update the time series database.

By automating the triage process, the system may help organizations more effectively respond to and manage security events. The system also allows analysts to focus on the most severe, relevant or ambiguous threats, and to more quickly determine an action for an alert, improving incident response and overall security posture of an organization.

Operating environments other than the one illustrated in FIG. 1 may also be used. For example, a different type of database or a memory data store may be used instead of the time series database and the web application may access the database over an API. An operating environment may include one or more processors configured to execute computer-readable instructions to configure the processor to perform any of the operations discussed herein. The computer-readable instructions may be stored in a memory or on a non-transitory computer-readable storage medium.

### Example Alert and Triage System-Training and Use

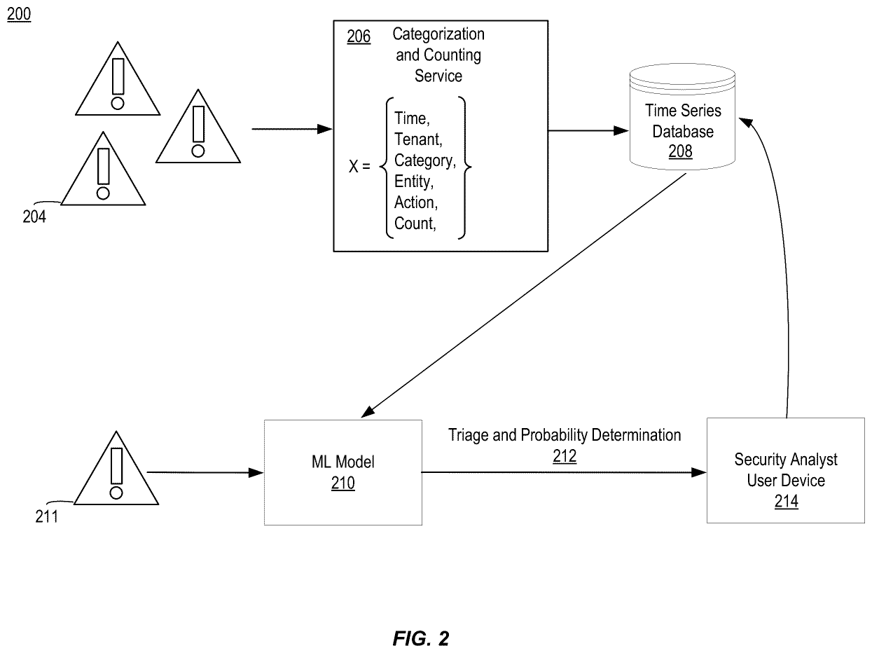

FIG. 2 illustrates a block diagram of an example alert and triage system 200 demonstrating the use of historical alert data to train the system and the use of historical alert data and new alert data to determine probabilities of potential actions for a newly received alert.

The alert and triage system 200 uses information associated with past or historical alerts 204, a counting service 206, a time series database 208, a machine learning model 210, and a security analyst user device 214. When a new alert 211 is received, it is processed by the system using the machine learning model 210.

The machine learning model 210 is trained using information associated with historical alerts 204. During training of the model, a feature vector is created for each historical alert. The feature vector includes information about the alert and the actions taken by an analyst for similar alerts in the past. A feature vector for a historical alert may include information such as the time the alert was generated, the tenant that generated the alert, the category of the alert, the entity/entities associated with the alert, and the action taken by an analyst. The counting service is used to identify similar alerts. The training data may include data for historical alerts that span a relatively long period of time (e.g., six months) as compared to the period of time associated with the time series database 208.

An alert category typically reflects an attack technique. There are potentially thousands of alert categories. Exemplary categories include, but are not limited to, Brute-force login attempt, denial-of-service attack, impossible travel login attempt, password spraying attempt, PowerShell Invoke-RestMethod Usage, WMI (Windows Management Instrumentation) event consumer contains suspect terms, Suspicious PowerShell WMI Persistence, searching for files containing passwords, Out of Band Data Extraction, and Rare Program/Rare IP.

An entity identifies a person, machine, program, or other digital object that operates within or interacts with a computing environment. The entities associated with an alert may include the location of its origin, the devices or assets from which the attack originated, and the devices or assets impacted by an attack. Exemplary entities include IP addresses and hostnames. An action is an outcome of the triage process. Typical outcomes include investigating the alert or labeling the alert.

The counting service provides the occurrence count of attributes of the historical alerts. Attributes include, but are not limited to, actions taken on the alert (e.g., investigated by an analyst), annotations made to the alert (e.g., labeled as malicious by an analyst), entities, the alert category, timestamp, and tenant. The counting service maintains many thousands of individual counts, to accommodate every attribute and combination of attributes. The counting service may be used to answer questions such as:
How many alerts within a certain time span were [investigated/labeled as malicious/labeled as not malicious, etc.]?
How many alerts within a certain time span within a certain category were [investigated/labeled as malicious/labeled as not malicious, etc.]?
How many alerts within a certain time span with a specific entity were [investigated/labeled as malicious/labeled as not malicious, etc.]?

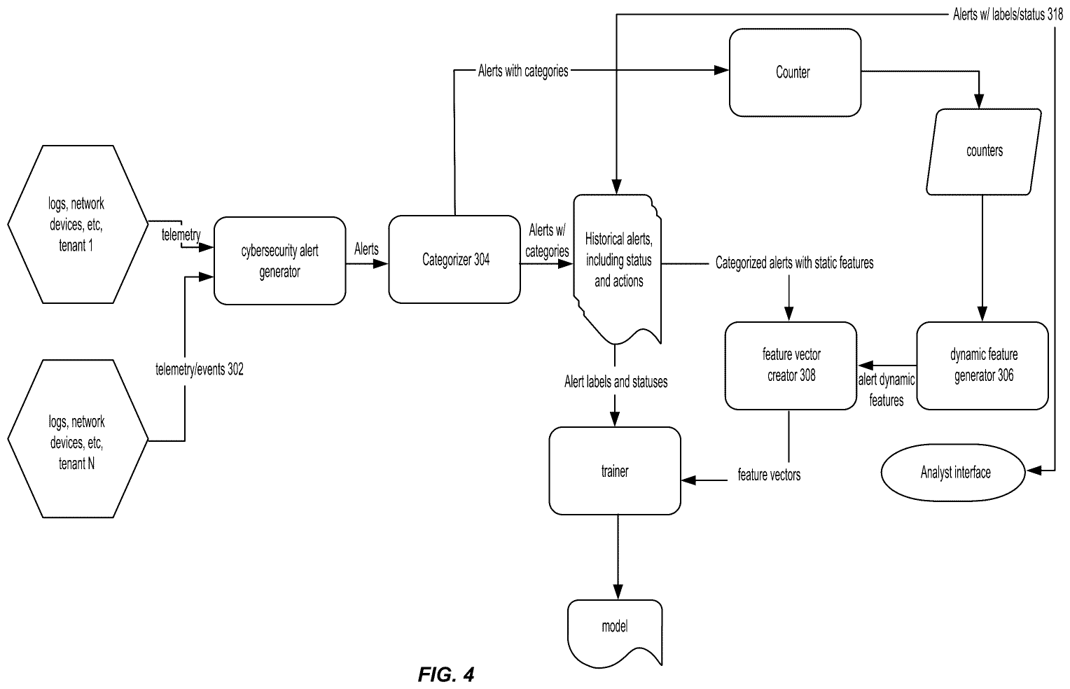

Certain categories of alerts may be extremely rare compared to others. Alerts belonging to such categories are represented in the training data to reduce the risk of poor predictions for rare, but still critical, alerts. To ensure a diverse corpus of training data, the system may employ a sampling mechanism. The sampling mechanism may provide data that can be used to validate and monitor the performance of the system. One such sampling method may include dynamic disproportionate stratified sampling where the strata are alert categories. This sampling procedure assigns a sampling probability to each alert category proportional to its rarity. The system may build an empirical distribution over the alert categories and may determine rarity of alerts based on this distribution and update the empirical distribution over time resulting in dynamic sampling probabilities. This sampling procedure assigns low sampling probability to very frequent alerts and similarly high sampling probability to rare alerts, allowing for equal representation of rare alerts in the training data. Additional details of training the model are discussed below in connection with FIG. 4.

As the system is processing new alerts, the system collects additional training data that can be used in an updated training cycle. The training data includes only alerts that were handled by an analyst. It does not include any alerts that were automatically handled by the system. Frequent retraining (e.g., hourly, daily, etc.) of the model is not required. The model learns the relationship between an action for an alert and the patterns of how similar alerts have been actioned in the recent and distant past.

The time series database 208 includes counters for previously received alerts that were handled by an analyst. In some examples, the time series database 208 stores count information for alerts received or processed during a set period of time, (e.g. the most recent 24 hours). In other examples, the time series database 208 stores counters for alerts received or processed during a varying period of time. The counters for the counting service may be maintained in the time series database 208 for a variable period of time in order to provide count information over prescribed time ranges. The set period of time or the variable period of time is shorter than the period of time associated with the historical alerts used for training.

The time series database 208 may include many thousands of counters which are updated as new alerts are received. In some examples, the counters maintain counts for alerts received from multiple tenants and for actions taken by multiple security analysts. The counters in the time series database enable the system to identify similar alerts without requiring the storage of historical alerts.

The system's use of a model trained with information from historical alerts and a time series database with information from more recent alerts enables the system to learn and react in real-time without the need for frequent retraining of the model. The more recent alerts capture current and emerging trends about a threat landscape, while the historical alerts capture long-term trends, rare categories of alerts, and provide a historical context for actions taken in the past by security analysts. For example, when looked at over a long period of time, alerts of certain categories are noisier than alerts of other categories and may be resolved by an analyst and labeled as benign. When alerts of a certain category have not been observed recently, capturing the likelihood that such alerts would be labeled as benign based on data observed over a longer time frame may improve predictions made by the model.

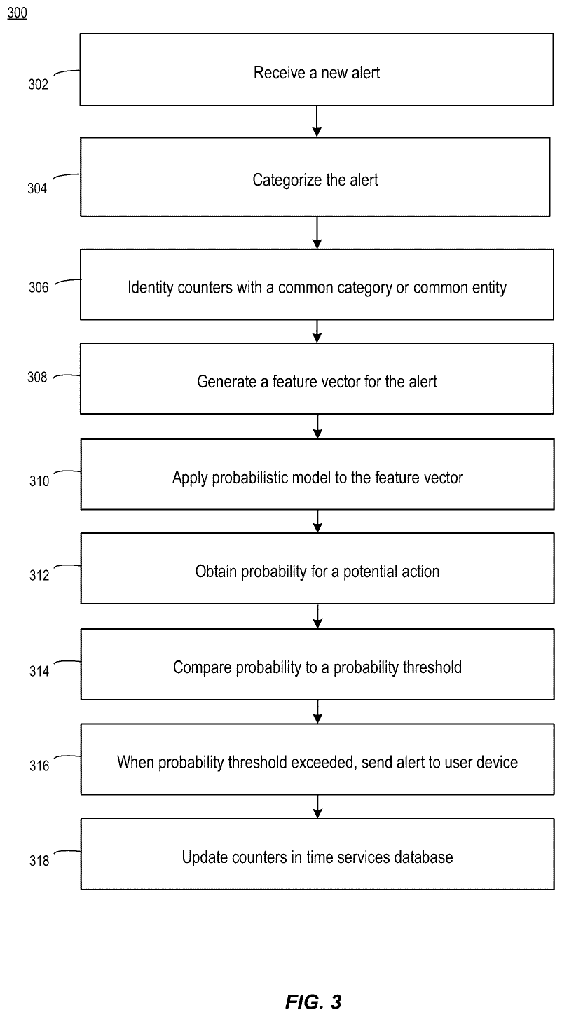

When a new alert 211 is received by the system, the system employs the concept of alert similarity. The system considers count information for similar alerts, e.g., count information from the time series database for alerts that have the same category or at least one common entity with the new alert. The system computes a feature vector for the new alert based on information from the new alert and count information for the similar alerts. Additional details of how the new alert is categorized and the generation of the feature vector for the new alert are discussed below in connection with FIG. 3.

The feature vector for the new alert 211 is applied as an input to the machine learning model 210. The machine learning model computes/calculates probabilities of actions for the new alert 211. When the computed probability for an action exceeds a predetermined probability threshold, the machine learning model outputs the new alert 211 and the action associated with the probability, as shown by the triage and probability determination 212, to the security analyst user device 214. When there are multiple probabilities that exceed the threshold, the system may provide a list of potential actions to the analyst. The list may be ranked based on the relative probabilities. The predetermined probability threshold may be selected by a system administrator based on the level of acceptable risk for the system implementation. Alternatively, the probability threshold may be dynamic and may be adjusted during operation. For example, the threshold may be dynamically adjusted based on considerations of how well the probability for an action tracks the actual action taken by an analyst.

If none of the probabilities exceed the probability threshold, then the system may send the new alert to the security analyst along with an indication that no actions were predicted.

A security analyst may review the new alert 211 provided by the security analyst user device 214 and perform an action to resolve the new alert 211. The system may store information reflecting the security analyst's action and the new alert 211 by updating the appropriate counters in the time series database 208. By providing actions for new alerts, the system can adapt its predictions to reflect current trends. For example, alerts that were once benign may become critical if there is a change in a network's architecture or a vulnerability is discovered. By allowing new alerts and recent actions by security analysts to be used for calculating probabilities by the machine learning model, the system may adapt faster to changes to a network's or system's security without requiring frequent retraining.

### Example Method of Processing an Alert

FIG. 3 illustrates an exemplary method 300 for processing a new alert. The method assumes that the machine learning model is already trained. At block 302, method 300 involves receiving a new alert associated with a security event. As further described in the description for FIG. 1 and FIG. 2, an alert may be a notification of suspicious or malicious activity. At block 304, the method involves categorizing the alert. If the system knows the rules or detection algorithm used to create the alert, then the system may use the rules/detection algorithm to categorize the alert. Once the alert is categorized, then the system can use the category to identify counters from the time series database that have the same category.

If the system does not know the rules/detection algorithm that created the alert or if the rules/detection algorithm are insufficient to categorize the alert, then the system categorizes the alert based on available text contained in the alert. For example, least common subsequences (LCS) followed by agglomerative clustering on the LCS may be used to categorize the alert. Natural language processing techniques, such as TF-IDF (Term Frequency-Inverse Document Frequency) or LDA (Latent Dirichlet Allocation) may be used to cluster the alerts. Other measures and methods of clustering may also be used to establish categories and correspond each alert to a category.

At block 306, the method identifies counters for similar alerts from the time series database. Similar alerts are those associated with the same category or with at least one of the same entities as the new alert. At block 308, the method creates a feature vector for the new alert. The feature vector includes static features and dynamic features. In one implementation, the feature vector includes over 20 dimensions. The static features may include or be based upon information from the alert. Exemplary static features may include, but are not limited to, the following:
Number of entities associated with the alert.
Number of relationships between the entities associated with the alert. Exemplary relationships may include a connection when host A attempts connection to host B or an execution action when program X executes on host C.
Threat level of an attack technique associate with the alert. In some examples, this may be the threat-level of the most threatening MITRE ATT&CK technique.
Number of attack techniques associated with the alert.
Number of event sources (e.g. authentication logs, IDS logs, firewall logs, process data, netflow data) that contributed to the creation of the alert.
Source(s) of information that generated the alert.
Frequency of alerts generated from the source(s) of the alert.

The dynamic features are derived using the counters in the time series database that have the same category or the same entity/entities as the current alert. The dynamic features may include ratios, such as the following
Ratio of number of alerts labeled as malicious to number of alerts labeled.
Ratio of number of alerts labeled to number of alerts.
Ratio of number of alerted investigated to number of alerts.
Ratio of number of alerts associated with a particular action to number of alerts with any action taken.
   In some implementations, the ratios include ratios specific to a specific tenant, as well as ratios across all tenants (global ratios).

Once the feature vector for the new alert is generated, the method applies the machine learning model to the feature vector in block 310. The machine learning model generates a set of probabilities, each probability associated with an action that may be taken with respect to the new alert in block 312. The machine learning model may include one or more of the following model families: logistic regression, random forests, gradient boosting trees, neural network, or any model that allows for either binary or multi-class label classification with a continuous range.

For each probability, the method determines whether the probability exceeds a probability threshold in block 314. When a probability exceeds the probability threshold, the new alert is provided to the analyst in block 316. The probability, the action associated with the probability, and/or other information used or determined by the machine learning model may also be sent to the analyst.

At block 318, the method updates the counters in the time series database to reflect the new alert and the action taken by the analyst. The action taken by the analyst may be the same as the action provided to the analyst or it may be different. The counters are updated using the actual action taken by the analyst.

In some implementations, if the probability exceeds the probability threshold, then the method automatically takes action for the new alert. For example, the method may label the alert as benign and log the alert without sending it to the analyst. If the method automatically takes action, then the alert is not used to update the counters in the time series database. The system may be configured so that only certain actions are eligible for automatic handling.

### Training Example

FIG. 4 illustrates an example of training the machine learning model 420 using historical alerts. A cybersecurity alert generator 404 generates alerts based on activity detected at a tenant 402a . . . 402n. A categorizer 406 categorizes the alerts and provides categorized alerts to a counting service 408. The counting service updates the appropriate counters 410. For example, a counter for alerts in a certain category with a given attribute may be adjusted, e.g., incremented, for an alert in that category having that attribute. The categorized alerts are also stored as historical alerts at 414. Since the alerts are ones that have already been handled by an analyst, the action taken by the analyst is stored for each alert. A feature vector creator 416 creates a feature vector for each historical alert. The feature vector includes static features, which are based on information from the historical alert. The feature vector also includes dynamic features generated by a dynamic feature generator 412. The dynamic features are based on the counts for the alert's category and entities. Therefore, the alert's dynamic features reflect the actions taken on similar alerts. The historical alerts and the feature vectors are provided to a trainer 418 and used to train the model 420.

### Real-Time Use Example

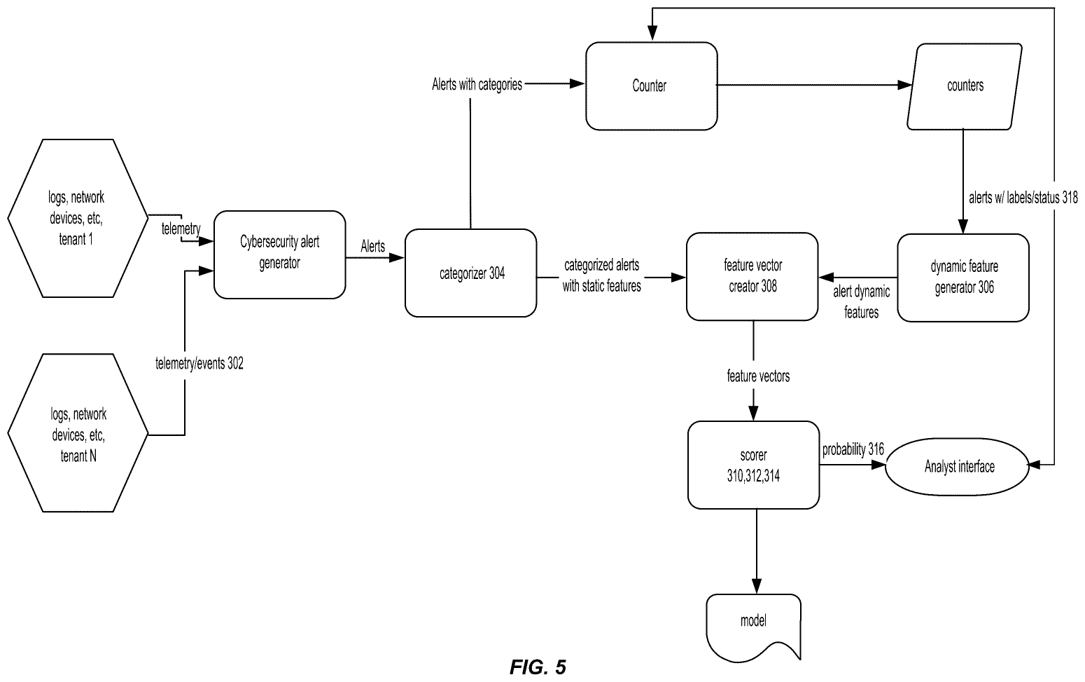

FIG. 5 illustrates an example of applying the machine learning model in real-time to new alerts. A cybersecurity alert generator 504 generates alerts based on activity detected at tenants 502a . . . 502n. A categorizer 506 categorizes the alerts and provides categorized alerts to a counting service 508. The counting service identifies counters for alerts having the same categories or at least one common entity from all of the counters 510 maintained in the time series database. The categorized alerts are also provided to a feature vector creator 516. The feature vector creator creates a feature vector for each alert. Each feature vector includes static features, which are based on information from the alert. The feature vector also includes dynamic features. A dynamic feature generator 512 generates the dynamic features using information from the counters for alerts having the same categories or at least one common entity. Since the counters count attributes and attribute combinations of received alerts by category and entity, the dynamic features include information for similar alerts, i.e., similar alerts may be identified through the counters. The model 520 processes the feature vectors and the scorer 522 provides a probability for a given action. When the probability exceeds a probability threshold, the alert and the action predicted by the model may be provided to analyst interface. Once the analyst takes an action on the alert, the action taken by the analyst is associated with the alert and the information is provided to the counting service 508 to update the counters 510.

### General Considerations

In the foregoing specification, aspects of the invention are described with reference to specific aspects thereof, but those skilled in the art will recognize that the invention is not limited thereto. Various features and aspects of the above-described invention may be used individually or jointly. Further, aspects can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, from a source, an alert associated with a security event, wherein the alert includes a title, a description, and identifies at least one entity;
identifying a category for the alert;
creating a feature vector for the alert that include static features based on information related to the alert and dynamic features based on count information derived from a plurality of similar alerts, wherein each of the similar alerts has a common category with the alert or at least one common entity with the alert and the count information is maintained for previously received alerts associated with a set period of time;
providing the feature vector to a probabilistic classification machine learning model;
obtaining a probability for an action for the alert from the probabilistic classification machine learning model;
determining whether the probability exceeds a probability threshold;
when the probability exceeds the probability threshold, providing the alert and the action associated with the probability to a user device;
receiving an analyst action for the alert; and
updating the count information based on the alert and the analyst action.

2. The method of claim 1, further comprising:
maintaining a plurality of counters to provide the count information for an alert attribute or a combination of alert attributes for a plurality of alerts associated with the set period of time.

3. The method of claim 1, wherein the probabilistic classification machine learning model is trained with historical alert data associated with a historical period of time, wherein the historical period of time covers a longer time period than the set period of time.

4. The method of claim 1, wherein obtaining at least one probability for an action from the probabilistic classification machine learning model comprises using a model that provides multi-class label classification with a continuous range.

5. The method of claim 1, further comprising:
when the probability does not exceed the probability threshold, providing the alert without any action to the user device.

6. The method of claim 1, wherein identifying a category of the alert comprises (i) using rules or a detection algorithm associated with the alert to identify the category or (ii) analyzing the title or the description of the alert to identify additional alerts and analyzing the additional alerts to identify the category.

7. The method of claim 1, wherein creating a feature vector for the alert comprises including at least one of the following ratios as a dynamic feature: (i) ratio of number of similar alerts labeled malicious to number of similar labeled alerts, (ii) ratio of number of similar alerts labeled to number of similar alerts, (iii) ratio of number of similar alerts investigated to number of similar alerts, (iv) ratio of number of similar alerts investigated and labeled malicious to number of similar alerts investigated and labeled.

8. The method of claim 1, further comprising:
determining a second probability for a second action for the alert from the probabilistic classification machine learning model;
determining whether the second probability exceeds the probability threshold; and
when the second probability exceeds the probability threshold, providing the alert and the second action associated with the probability to the user device.

9. The method of claim 1, further comprising:
receiving a second alert;
identifying a second category for the second alert;
creating a second feature vector for the second alert;
providing the second feature vector to the probabilistic classification machine learning model,
obtaining a second probability for a predicted action for the second alert from the probabilistic classification machine learning model;
determining whether the second probability exceeds a second probability threshold; and
when the second probability exceeds the second probability threshold, automatically proceeding to the predicted action.

10. A method comprising:
receiving, from a source, an alert associated with a security event, wherein the alert includes at least one entity;
identifying a category for the alert;
creating a feature vector for the alert that include static features based on the alert and dynamic features based on count information derived from a plurality of similar alerts, wherein each of the similar alerts has a common category with the alert or at least one common entity with the alert and the count information is maintained for previously received alerts associated with a set period of time;
providing the feature vector to a probabilistic classification machine learning model trained using historical alerts associated with a historical period of time, wherein the historical period of time covers a longer time period than the set period of time;
obtaining at least one probability for an action from the probabilistic classification machine learning model;
determining whether the at least one probability exceeds a probability threshold;
when the at least one probability exceeds the probability threshold, providing the alert and the action associated with the probability;
receiving an analyst action for the alert; and
updating the count information based on the alert and the analyst action.

11. The method of claim 10, wherein identifying a category of the alert comprises (i) using rules or a detection algorithm associated with the alert to identify the category or (ii) analyzing textual information associated with the alert to identify additional alerts and analyzing the additional alerts to identify the category.

12. The method of claim 10, further comprising:
maintaining a plurality of counters to provide the count information for an alert attribute or a combination of alert attributes for a plurality of alerts are associated with the set period of time.

13. The method of claim 12, wherein updating the count information based on the alert and the analyst action, comprises updating at least one counter associated with the category for the alert or with the at least one entity associated with the alert.

14. The method of claim 10, wherein obtaining at least one probability for an action from the probabilistic classification machine learning model comprises using a model that provides multi-class label classification with a continuous range.

15. The method of claim 10, wherein creating a feature vector for the alert includes including at least one ratio of a number of similar alerts associated with a selected action to a number of similar alerts associated with all other actions.

16. A system for processing alerts associated with security events, comprising:
an interface for receiving a plurality of alerts from a plurality of tenants, wherein each alert is associate with a security event detected at one of the tenants;
a time series database storing a plurality of counters, wherein each counter maintains a count of alert attributes or combinations of alert attributes for alerts associated with a set period of time;
a probabilistic classification machine learning model trained using historical alerts associated with a historical period of time, wherein the historical period of time covers a longer time period than the set period of time; and
a processor configured for executing computer readable instructions that when executed by the processor cause the processor to:
receive a first alert;
categorize the first alert;
create a first feature vector for the first alert that includes static features based on the first alert and dynamic features based on the counters maintained in the time series database;
provide the first feature vector to the probabilistic classification machine leaning model;
obtain a first probability for a first action for the first alert from the probabilistic classification machine learning model;
determine whether the first probability exceeds a first probability threshold; and
when the first probability exceeds the first probability threshold, automatically taking the first action for the first alert.

17. The system of claim 16, wherein the processor is further caused to:
receive a second alert;
categorize the second alert;
create a second feature vector for the second alert that includes static features based on the second alert and dynamic features based on the counters maintained in the time series database;
provide the second feature vector to the probabilistic classification machine leaning model;
obtain a second probability for a second action for the second alert from the probabilistic classification machine learning model;
determine whether the second probability exceeds a second probability threshold;
when the second probability exceeds the second probability threshold, providing the second alert and the second action to an analyst;
receiving an analyst action for the second alert; and
updating the counters in the time series database based on the second alert and the analyst action.

18. The system of claim 16, wherein the processor is further caused to maintain the time series database by updating the counters to include counts for alerts associated with the set period of time.

19. The system of claim 16, wherein the processor is further caused to categorize the first alert by (i) using rules or a detection algorithm associated with the first alert to identify a category or (ii) analyzing textual information associated with the first alert to identify additional alerts and analyzing the additional alerts to identify the category.

20. The system of claim 17, wherein the processor is further caused to generate the dynamic features by generating a ratio of a number of similar alerts associated with a selected action to a number of similar alerts associated with all other actions.
